(19) United States
(12) Patent Application Publication
(10) Pub. No.: US 2006/0046775 A1
(43) Pub. Date: Mar. 2, 2006

(54) Intelligent antenna and method for configuring the same

(76) Inventor: Edward W. Geiger, San Martin, CA (US)

Correspondence Address: FAY KAPLUN & MARCIN, LLP, 15O BROADWAY, SUITE 702, NEW YORK, NY, 10038, US

(21) Appl. No.: 10/930,502

(22) Filed: Aug. 31, 2004

(51) Int. Cl. H04M 1/00

(52) U.S. Cl. 455/556.1

(57) ABSTRACT

Describes is an antenna which includes a memory storage device storing authorized use data corresponding to wireless communication restrictions and a data connection connected to the memory storage device. When the antenna is connected to a computing device, the authorized use data is transferred from the memory storage device to the computing device to determine authorized wireless usage of the computing device in combination with the antenna as a function of the authorized use data. The computing device includes a wireless radio transducer.

### FIELD OF INVENTION

The present invention relates generally to an antenna for a computing device with a wireless radio transducer, and, in particular, to an intelligent antenna with a memory storage device for storing information.

### BACKGROUND INFORMATION

Regulatory bodies in most countries restrict signal power levels of various frequencies to accommodate needs of users and to avoid radio frequency (“RF”) interference. Based on testing, a regulatory body may limit the maximum power of a specific device based upon the channel, location of use (e.g., indoor or outdoor use), antenna gain, spectral mask, and pattern of the antenna. For example, antennas and transmitters produced in the United States must comply with Federal Communications Commission (“FCC”) rules regarding the maximum equivalent isotopically radiated power (“EIRP”). EIRP represents the total effective transmitted power, including gains that the antenna may provide and losses from an antenna cable.

Storing of the information regarding the maximum EIRP of various APs and/or antennas requires extensive record keeping, databases, etc. In addition, the maximum EIRP may need to be revised if an antenna is added or changed. Typically, an installer or user is required to identify the type of antenna(s) being used with the AP, look up the antenna limitations in a document and implement those limitations when configuring a switch. However, the current method is time consuming and is prone to abuse as a user may ignore the regulatory requirements and set power levels above the regulatory limits.

### SUMMARY OF INVENTION

The present invention relates to an antenna includes a memory storage device storing authorized use data corresponding to wireless communication restrictions and a data connection connected to the memory. When the antenna is connected to a computing device, the authorized use data is transferred from the memory storage device, via the data connection, to the computing device to determine authorized wireless usage of the computing device in combination with the antenna as a function of the authorized use data.

### BRIEF DESCRIPTION OF THE DRAWINGS

FIG. 1 shows an exemplary system according to the present invention.

FIG. 2A shows an exemplary embodiment of an intelligent antenna according to the present invention.

FIG. 2B shows a top view of the antenna of FIG. 1A.

FIG. 3 shows another exemplary embodiment of the antenna according to the present invention.

FIG. 4 shows an exemplary embodiment of a memory storage device of the antenna according to the present invention.

FIG. 5 shows a method of configuring a computing device in combination with the antenna according to the present invention.

### DETAILED DESCRIPTION

The present invention related to an intelligent antenna and method for configuring the same. In particular, the antenna allows a computing device having a wireless radio transducer to identify authorized regulatory limitations imposed on wireless communications, e.g., by FCC or any other regulatory agencies. The present invention may eliminate the need to configure the antenna gain for each computing device during an installation process. The present invention also allows an authorized user to remotely identify the antenna attached to each computing device using a graphical user interface (“GUI”) and provides updates, if necessary. Furthermore, the present invention eliminates possibility that an unauthorized user can configure the computing device to have certain antenna gain and radio power which are combined to exceed imposed regulatory limits.

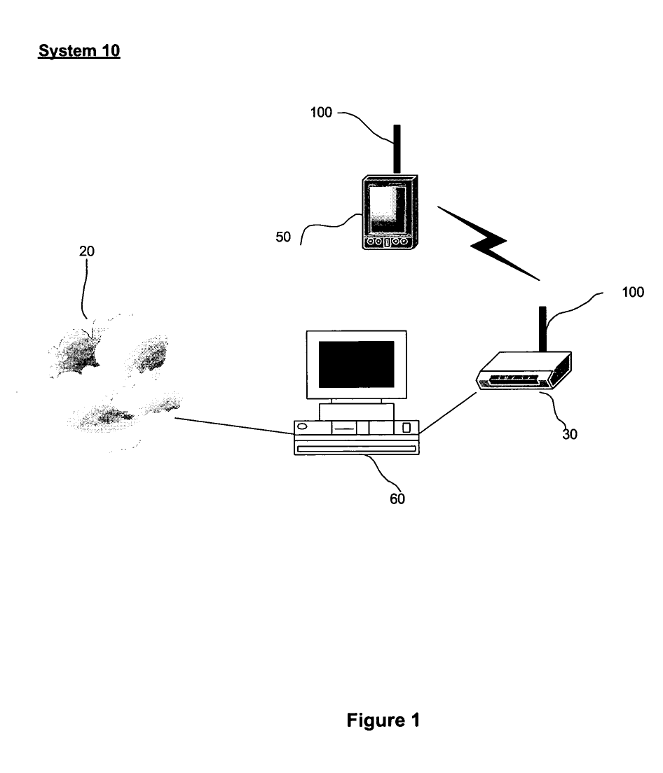

FIG. 1 shows an exemplary system 10 according to the present invention. The system 10 may include a communications network 20 which may include, for example, a local area network (“LAN”), an Intranet, a wireless LAN, the Internet, or a cellular network. The system 20 may include a plurality of computing device that have wireless communication capability, e.g., an access point (“AP”) 30 and a mobile unit 50 (e.g., a radio or mobile phone, a PDA, etc.). The APs 30 may be used by a computer 60 to communicate with the mobile unit 50 and to provide the mobile unit 50 access to the communications network 20.

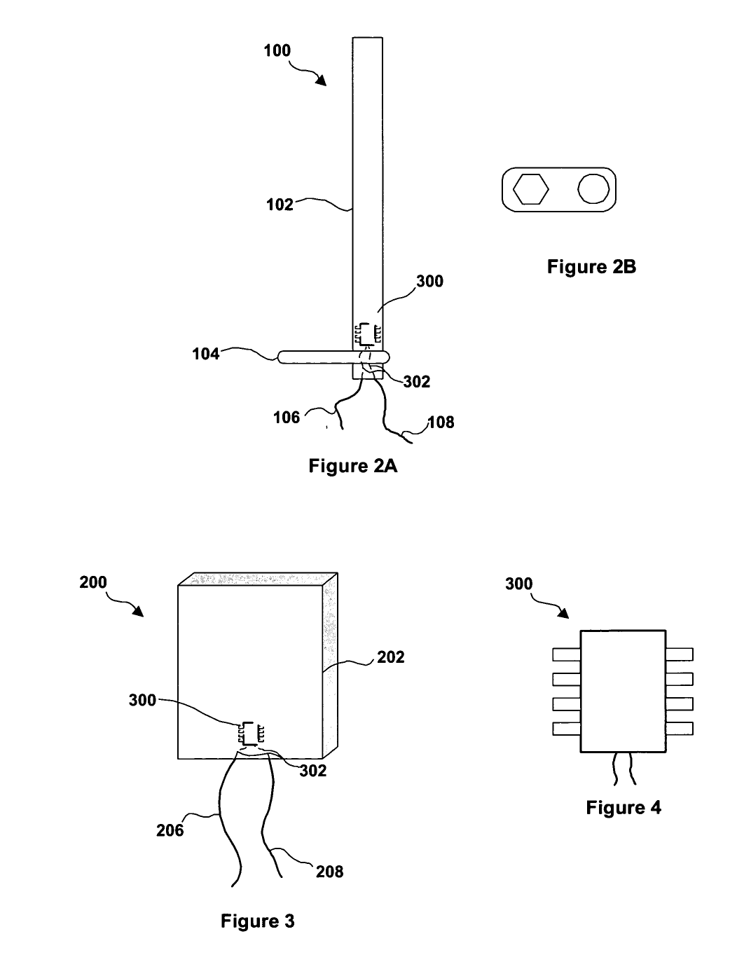

The AP 30 and the mobile unit 50 includes an intelligent antenna 100, and a wireless radio transducer (not shown). The AP 30 and the mobile unit may also include a processor (not shown). FIGS. 2A and 2B show an exemplary embodiment of the antenna 100 according to the present invention. The antenna 100 may be adapted for use in combination with any computing device (e.g., the mobile unit 50, the AP 30, etc.). The antenna 100 may be, for example, an omni-directional mast mount antenna. The intelligent antenna 100 includes an antenna casing 102. As shown in FIG. 2B, the antenna casing 102 of the exemplary embodiment may have a circular cross-section. The antenna 100 may also include a tube end mount 104 to secure the antenna casing 102 in a fixed location.

The antenna 100 may also include a ground wire 106 and an antenna feed 108 (e.g., a further data connection). As one of ordinary skill in the art would understand, the antenna feed 108 may transmit data (e.g., a radio signal/data) between the computing device and the antenna 100. The ground wire 106 provides a conducting path to the earth which is independent of the antenna feed 108.

FIG. 3 shows another exemplary embodiment of an intelligent antenna 200 according to the present invention. The antenna 200 may be a high gain directional type antenna. The antenna 200 may include an antenna casing 202. The antenna casing 202 may have a substantially rectangular shape. However, as one of ordinary skill in the art would understand, the antenna casing 202 may be of any shape and size required for a specific application. The antenna 200 may also include a ground wire 206 and an antenna feed 208 (e.g., a further data connection).

FIG. 4 shows an exemplary embodiment of a memory storage device 300 according to the present invention. The memory device 300 may include an electrically erasable programable read-only memory (“EEPROM”). For example, the memory device 300 may be a two-wire EEPROM device of any size, shape, and capacity known to those of ordinary skill in the art. The memory device 300 may be secured at any location within or upon the antenna 100/200.

The antenna 100/200 also includes a data connection 302 to allow for the transfer of data to and from the memory device 300. The data connection 302 may include any means of transferring data known to those of skill in the art. For example, the data connection 302 may comprise the existing wires of the antenna 100/200. The data connection 302 shown in FIG. 2A includes a connection to the ground wire 106 and antenna feed 108. Therefore, the memory device 300 may transfer data to/from the computing device via the ground wire 106 and the antenna feed 108. Likewise, the data connection 302 shown in FIG. 3 includes a connection to the ground wire 206 and the antenna feed 208. As one of skill in the art will understand, technical or physical limitations may exist in certain applications that limit the feasibility of transferring data to and from the memory device 300 via existing antenna wires. In such cases, the data connection 302 may include one (1) or two (2) pins added to an antenna connection to accommodate the memory device 300.

The memory device 300 in the antenna 100/200 may stored certain information/data. For example, the memory device 300 may store information identifying the antenna (e.g., a model number or type identifier), and regulatory and operating information for the antenna 100/200 and the computing device. For example, such information (e.g., authorized use data) may include the maximum power based upon the channel, location of use (e.g., indoor or outdoor use), antenna gain, spectral mask, and pattern of the antenna. The information may include, for example, FCC wireless communications restrictions. In particular, the memory device 300 may store information specific to each RF channel, a regulatory body (e.g., country), power and gain. The information may be stored in the memory device 300 upon manufacture of the antenna 100/200. Furthermore, the information stored in the memory device 300 may be erased or updated directly (e.g., where the antenna 100/200 is connected directly to a computer) or remotely (e.g., where the antenna 100/200 is connected to a computing device which is connected to the Internet) by an authorized user. The information may be formatted or encrypted to prevent unauthorized users from modifying the information to allow non-compliance to regulatory requirements.

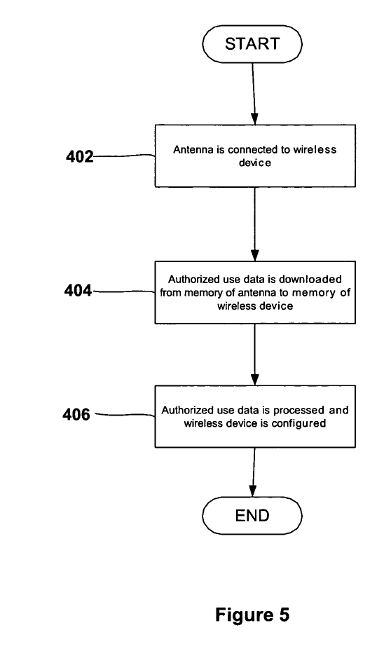

FIG. 5 shows an exemplary method of combining and utilizing the antenna 100/200 with the computing device (e.g., the mobile unit 50, the AP 30, etc.) according to the present invention. In the step 402, the antenna 100/200 is installed/connected to the computing device. In particular, the data connection of the antenna 100/200 is connected to, for example, corresponding data connection of the computing device.

In the step 404, the authorized use data stored in the memory 300 is downloaded into a memory of the computing device via the set of data connections. In the step 406, the computing device processes the authorized use data to extract information about the antenna 100/200 and the authorized use data. Based on this authorized use data, the computing device configures itself to be utilized with the antenna 100/200 and for the specific authorized usage. For example, as described above, the authorized usage may include limitation on RF requirements for wireless communications, etc. Once the configuration is completed, the computing device with the antenna 100/200 may engage in wireless communications.

One of the advantages of the present invention is a user (e.g., a manufacture, a reseller, etc.) is allowed to configure the antenna 100/200 for a specific purpose. For example, the user may program the memory 300 so that the antenna 100/200 and the computing device may be used only in a single geographical region or within a predetermined frequency range. Such antenna configuration may performed via the GUI when the antenna 100/200 connected directly or remotely (e.g., the Internet) to a computing device. In addition, the present invention allows the user to update the authorized use data as necessary (e.g., to update latest changes of the FCC regulations regarding wireless communications).

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. An antenna, comprising:
a memory storage device storing authorized use data corresponding to wireless communication restrictions; and
a data connection connected to the memory storage device,
wherein when the antenna is connected to a computing device, the authorized use data is transferred from the memory storage device, via the data connection, to the computing device to determine authorized wireless usage of the computing device in combination with the antenna as a function of the authorized use data, the computing device including a wireless radio transducer.

2. The antenna according to claim 1, wherein the memory storage device further include configuration data to allow configuration of the computing device in combination with the antenna.

3. The antenna according to claim 2, wherein the configuration data includes at least one of a model number of the antenna and a type identifier of the antenna.

4. The antenna according to claim 1, wherein the wireless radio transducer is configured to wirelessly communicate based the authorized use data.

5. The antenna according to claim 1, wherein memory storage device includes an electrically erasable programmable read-only memory.

6. The antenna according to claim 1, wherein the authorized use data is encrypted.

7. The antenna according to claim 1, further comprising:
a further data connection connecting the antenna to the computing device, the computing device wirelessly communicating using the antenna via the further data connection.

8. The antenna according to claim 1, wherein the authorized use data includes at least one of a maximum power based upon a wireless channel, a location of use of the computing device, an antenna gain, a spectral mask and pattern of the antenna.

9. The antenna according to claim 1, wherein the authorized use data stored in the memory storage device is updated by an authorized user via the computing device.

10. The antenna according to claim 9, wherein the authorized user updates the authorized use data remotely using a further device communicating with the computing device.

11. An arrangement, comprising:
an antenna including a memory storage device and a data connection connected to the memory storage device, the memory storage device storing authorized use data corresponding to wireless communication restrictions; and
a computing device including a wireless radio, a processor and a further memory storage device, wherein the antenna is connected to the computing device, the authorized use data is transferred from the memory storage device, via the data connection, to the further memory storage device, the processor determining authorized wireless usage of the wireless radio in combination with the antenna as a function of the authorized use data.

12. The arrangement according to claim 11, wherein the computing device includes at least one of an access point, a mobile computing device, a wireless pager, and a wireless radio transducer.

13. The arrangement according to claim 11, wherein the memory storage device further include configuration data to allow configuration of the computing device in combination with the antenna.

14. The arrangement according to claim 13, wherein the configuration data includes at least one of a model number of the antenna and a type identifier of the antenna.

15. The arrangement according to claim 11, wherein the wireless radio is configured to wirelessly communicate based on the authorized use data.

16. The arrangement according to claim 11, wherein memory storage device includes an electrically erasable programmable read-only memory.

17. The arrangement according to claim 11, wherein the authorized use data is encrypted.

18. The arrangement according to claim 11, wherein the antenna includes a further data connection connecting the antenna to the computing device, the computing device wirelessly communicating using the antenna via the further data connection.

19. The arrangement according to claim 11, wherein the authorized use data includes at least one of a maximum power based upon a wireless channel, a location of use of the computing device, an antenna gain, a spectral mask and pattern of the antenna.

20. The arrangement according to claim 11, wherein the authorized use data stored in the memory storage device is updated by an authorized user via the computing device.

21. The arrangement according to claim 20, wherein the authorized user updates the authorized use data remotely using a further device communicating with the computing device.

22. A method, comprising the steps of:
connecting an antenna to a computing device, the antenna including a memory storage device and a data connection connected to the memory storage device, the memory storing authorized use data corresponding to wireless communication restrictions, the computing device including a wireless radio, a processor and a further memory storage device;
downloading the authorized use data to the further memory storage device; and
determining with the processor an authorized wireless usage of the wireless radio in combination with the antenna as a function of the authorized use data.

23. The method according to claim 22, wherein the memory storage device further include configuration data to allow configuration of the computing device in combination with the antenna.

24. The method according to claim 22, further comprising the step of:
configuring the wireless radio for wireless communications based on the authorized use data.

25. The method according to claim 22, wherein the authorized use data is encrypted, and the method is further comprising the step of:
before the determining step, decrypting the authorize use data.

26. The method according to claim 22, further comprising the step of:
updating the authorized use data stored in the memory storage device by an authorized user via the computing device.

27. The method according to claim 26, wherein the updating step is performed by the authorized user remotely using a further device communicating with the computing device.
